(19) United States
(12) Patent Application Publication
(10) Pub. No.: US 2025/0256684 A1
(43) Pub. Date: Aug. 14, 2025

(54) UNIVERSAL WINDSHIELD WIPER ASSEMBLY

(71) Applicant: Benio Simor Kalka, Fillmore, CA (US)

(72) Inventor: Benio Simor Kalka, Fillmore, CA (US)

(21) Appl. No.: 18/439,414

(22) Filed: Feb. 12, 2024

(51) Int. Cl. B60S 1/26; B60S 1/04

(52) U.S. Cl. CPC B60S 1/26; B60S 1/0425

(57) ABSTRACT

A universal windshield wiper blade assembly for use with all aircraft, both commercial and military that removes the necessity of having assemblies for each individual type of aircraft in existence at locations where aircraft fly in and out. The system utilizes individual mounts for individual types of aircraft that permanently installed after which the universal windshield wiper assembly is installed thereon. The universal windshield wiper assembly includes a gear box with a shaft that attaches to a windshield wiper arm that moves and windshield wiper blade, an electric motor, including internally and externally commutated as well as asynchronous motors that actuates the gear box and a motor cover that has housed therein electronics that include preset specifications for individual aircraft types.

### BACKGROUND OF THE INVENTION

### Field of the Invention

The field of this invention relates generally to the field of windshield wiper assemblies and more particularly toward a universal windshield wiper assembly that can be used for any type of aircraft.

### Description of the Prior Art

Typically, an aircraft operated for passenger and for military has two separate and distinct motor/converters assemblies for windshield wiper blades, one for the left side and one for the right side of the aircraft cockpit. Due to a large variety of motor/converter assembly products on various aircraft, a large number of motor/converters need to be on hand for preventive and/or corrective maintenance of the windshield wiper blades.

For example, if an airline is operating five different types of aircrafts, under existing technologies, the airline would have to stock ten distinct motor/converters assemblies at every depot that it flew planes in order to prevent an aircraft on the ground (AOG) situation. AOG refers to an aircraft failure to be able to operate properly. An AOG is an unexpected event and can occur at any time due to weather or equipment failure. This kind of situation creates delays and public relations nightmares for airlines along with high costs. Large aircraft manufacturer Boeing estimates that 1 to 2 hours AOG costs between $10K to $20K. Sometimes passengers are required to deplane with the airplane providing hotel stays with paid meals and transport.

No airplane can fly without a windshield wiper. If a plane has no windshield wiper the plane is now AOG (airplane on the ground). If you have 150 passengers on a given flight, an AOG situations means that the passengers have to get off the plane and be sent to a hotel. This is nearly always the result of a windshield wiper malfunction because of the practical fact that the airlines cannot stock every motor converter for every plane they operate in every depot. From the smallest to largest, every motor/converter is different.

Additionally, with regard to windshield wiper motor/converters, they are noisy and pilots do not like the sound.

It is the primary object of the instant invention to provide a system and method for reducing and/or preventing AOG situations with regard to windshield wiper blades by providing a universal windshield wiper assembly that can be used on all aircraft.

It is a secondary object of the instant invention to provide a windshield wiper assembly that eliminates the noise products by prior art devices.

### SUMMARY OF THE INVENTION

The basic embodiment of the present invention teaches a universal windshield wiper assembly for aircraft comprising: a gear box; a shaft attached to said gear box for affixing to a windshield wiper arm; a motor to turn said gear box; electronics that are pre-programmed with presets to match specifications of any specific type of aircraft; and a motor cover with said electronics embedded therein.

The above embodiment can be further modified by defining that wherein said motor is internally commutated.

The above embodiment can be further modified by defining that said motor is externally commutated.

The above embodiment can be further modified by defining that said motor is asynchronous.

An alternate embodiment of the instant inventions provides for a system for providing a universal windshield wiper blade assembly at aircraft depots that can be used with any type of aircraft, said system further comprising: individual mounts for permanent installation on a specific type of aircraft; pre-set electronic programming that includes specifications for of said specific type of aircraft; embedding of said electronic programming inside a motor cover for said universal windshield wiper blade assembly; placing said motor cover over a motor; connecting said motor to a gear box, said gear box including a shaft that attaches to a windshield wiper blade; selecting the pre-set electronic programming for said specific type of aircraft on a first side of a cockpit of said specific type of aircraft; and selecting the pre-set electronic programming for said type of aircraft on an opposing side of said cockpit of said specific type of aircraft.

The above embodiment can be further modified by defining that wherein said motor is internally commutated.

The above embodiment can be further modified by defining that said motor is externally commutated.

The above embodiment can be further modified by defining that said motor is asynchronous.

An alternate embodiment provides for a method of installing at universal windshield wiper assembly on any type of aircraft, said method comprising the steps of: providing a universal windshield wiper assembly, said universal windshield wiper assembly further comprising: a gear box; a shaft attached to said gear box for affixing to a windshield wiper arm; a motor to turn said gear box; electronics that are pre-programmed with presets to match specifications of any specific type of aircraft; and a motor cover with said electronics embedded therein; selecting from said presets for a specific type of aircraft onto which said universal windshield wiper assembly is to be installed; affixing said: universal windshield wiper assembly on to a first side of a windshield to permanently installed mounts on said specific type of aircraft; testing on said first side; and affixing said universal windshield wiper assembly on to an opposite side of said windshield to said permanently installed mounts on said specific type of aircraft.

The above embodiment can be further modified by defining that said motor is internally commutated.

The above embodiment can be further modified by defining that said motor is externally commutated.

The above embodiment can be further modified by defining that said motor is asynchronous.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is an exploded view of an exemplary prior art system for windshield wiper assemblies for aircraft.

FIG. 2 is an exploded view of the universal windshield wiper assembly of the instant invention.

FIG. 3 is a top view of the assembled universal windshield wiper assembly of the instant invention.

FIG. 4 is a side view of the assembled universal windshield wiper assembly of the instant invention.

FIG. 5 is a front-end view of the assembled universal windshield wiper assembly of the instant invention.

FIG. 6 is a flow chart indicating the use and parts of the universal windshield wiper assembly of the instant invention.

### DETAILED DESCRIPTION OF A PREFERRED EMBODIMENT

Turning to the drawings, the preferred embodiment is illustrated and described by reference characters that denote similar elements throughout the several views of the instant invention.

The preferred embodiment of the instant invention provides for a convertor style motor/convertor assembly for use in a universal windshield wiper assembly. The converter is the device that turns the rotary motion of the motor into the reversible action of the windshield wiper, just like on a car. The instant invention uses an electric motor, including internally and externally commutated as well as asynchronous motors, which allows the gear to go back and forth over a set number of degrees. The motor can be instructed electronically regarding how much torque to put out to match the requirement of an individual plane. Similarly, the number of degrees that the wipers will swing and the parking position can be programmed electronically as well. The torque, the degree of swing, the speed and the parking position are programmable for each individual aircraft. There is no need, with the instant system, to replace the switch that turns on and sets the speeds. The instant invention seeks to simplify modern automotive systems which have features such as automatically turning on when rain starts, which is not desired by the instant design.

The lifetime of a bolt style prior art motor converters is five years. The cost is $25-45K a piece and there are two on each airplane. The instant invention seeks to build a different frame than what exists to hold a motor converter, which in the instant system is really a motor gear box rather than a motor converter, which is the terminology for prior existing systems. In order to mount the gear box of the instant system, there are different mounting platforms which are individual and different for each side of each aircraft never need to be replaced, i.e., it would never come off again and would become a permanent installation.

Airlines operate their airplanes in terms of safety considerations. According to a series of checks, ending with a d-check which is a complete demobilization of the aircraft, i.e., the removal of major systems like the panel, making it entirely accessible. To install and use the instant system, the meter is installed which is coded to detect and indicate the specific individual plane type and which side of the windshield the assembly is located. Like testers you have on a car, this process takes only a matter of seconds, after which, assembly should be easy and clean. Preliminary coding and testing will provide that the motor knows the torque, speed and other requirements of the original specification that the aircraft manufacturer previously provided.

The assembly is universal and would fit in all airplanes and helicopters whether or not it is an aircraft with a pair of one piece motor converters, or a system that operates with one motor driving two separate converters using flexible shafts to turn the converter. The instant invention uses a specialized motor/converter assembly that uses an electric motor, including internally and externally commutated as well as asynchronous motors which typically lasts longer than the traditional DC electric motors used in windshield wipers. The manufacturing costs of internally and externally commutated and synchronous motors have come down considerably making them an even more competitive option. Furthermore, these stepper and brushless motors are stronger and have more torque over other styles of motor. The motors use an optical encoder to tell the system where the motor is, essentially created a closed loop system.

One of the disadvantages of the current system is the noise especially of the converter, which is eliminated by the instant system Internally and externally commutated and synchronous motors have the additional advantage of being quieter than traditional DC motors. Further, internally and externally commutated and synchronous motor assemblies have fewer moving parts, which makes them less susceptible to breakage.

While the time needed to replace the motor will remain about the same, the fact of universality of the method provides a remedy for situations when windshield wipers on aircraft need changing without the need for multiple styles being kept in stock at each depot. The three main components in the assembly are as follows: the Internally and externally commutated and synchronous motor controller, the internally and externally commutated and synchronous motor driver and the internally and externally commutated and synchronous motor itself. There are no complicated levers or gears. The SMC sends an input pulse signal to the driver, which in turn provides the power to turn the motor. The motor controller is an integral part of the system and it is programmable for each aircraft model. Once programmed, the controller will tell the system: (a) the sweep range of the wiper blade, (b) the home position (parking place), (c) the wiping speed and (d) type of cycle.

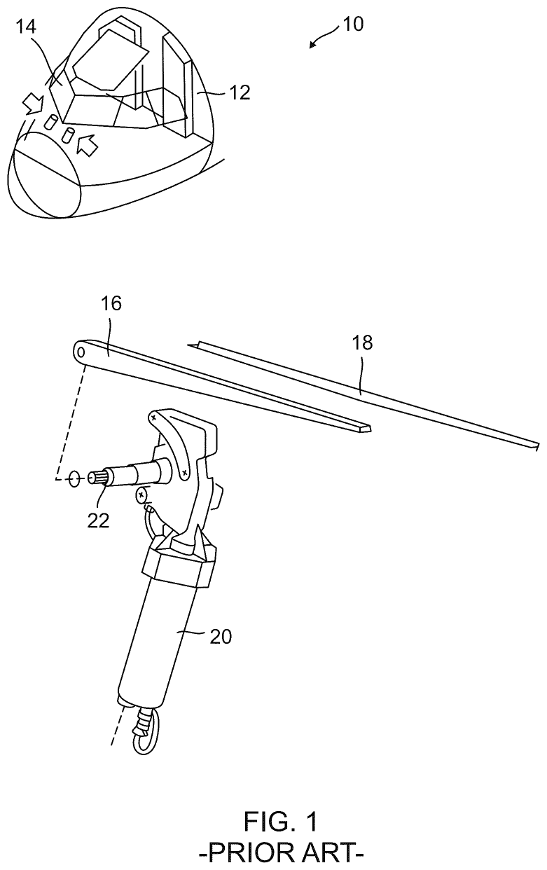

FIG. 1 illustrates a typical prior art assembly 10. Illustrated is the cockpit 12 of an airplane where the windshield 14 is shown. The windshield 14 is where the wiper blade assembly would be affixed. Existing systems include a motor with a shaft 22 that attaches to a wiper arm 16 that moves a wiper blade 18. Each type aircraft has its own specifications and hence the assembly is individual to each type of aircraft. As explained, the instant invention seeks to simplify the system to individual mounts for each plane, but with a universal wiper blade assembly 24.

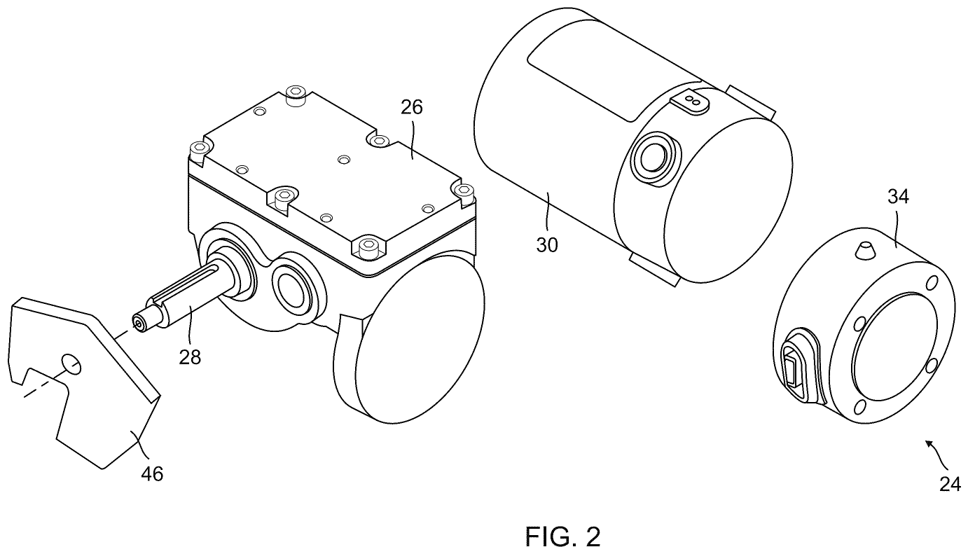

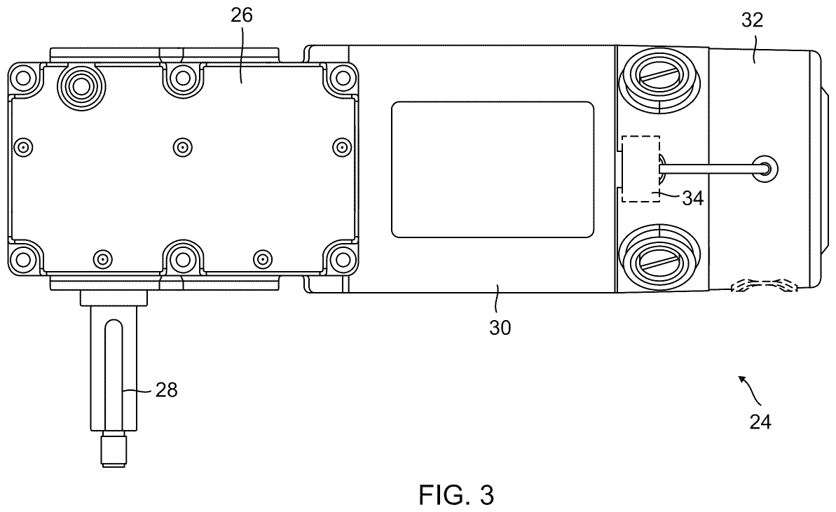

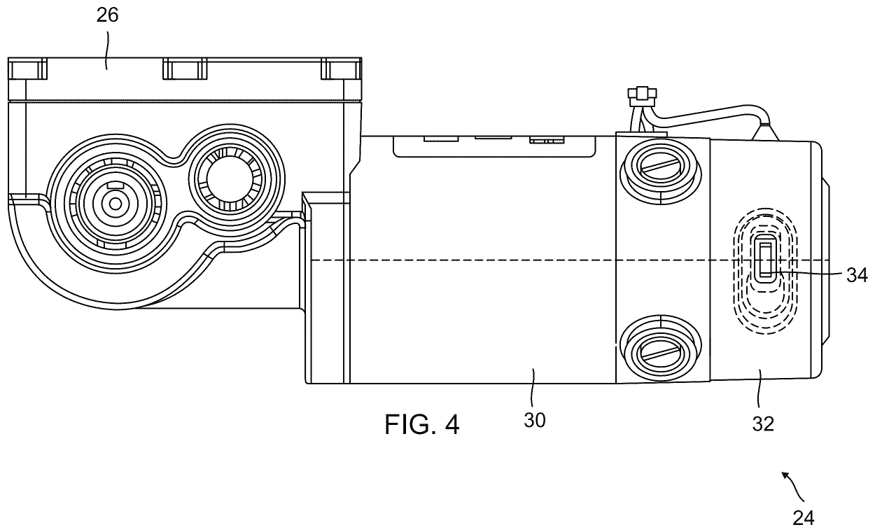

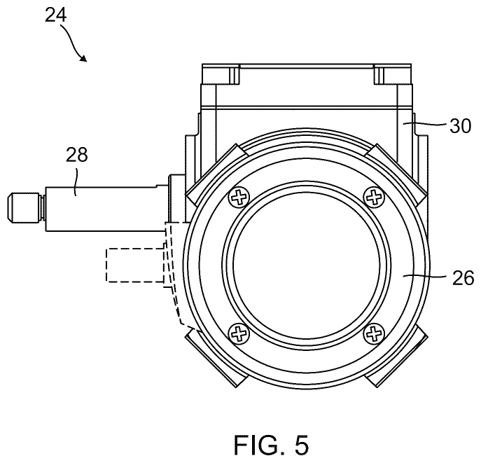

The mounts (not shown) are not a distinct structural part of the instant invention and hence they are not illustrated, but they would be positioned near the windshield 14 on the cockpit 12 of an individual aircraft. The assembly 24 of the instant invention is composed of three main components, shown exploded in FIG. 2 and intact in FIGS. 3-5 at different angles. These main components are the gear box 26 with rotating shaft 28, the motor 30 which is an electric motor that includes choices between internally and externally commutated as well as asynchronous motors and a motor cover 34 inside of which are housed the electronics that are programmed with presets for the specifications of each type of aircraft.

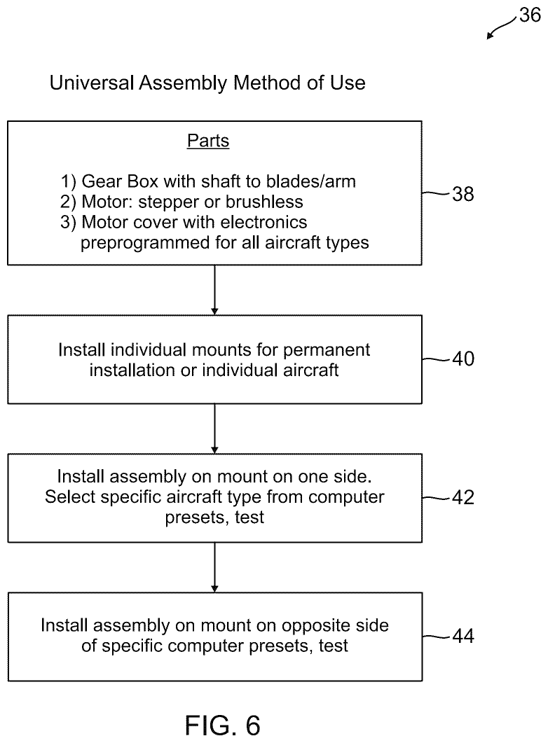

FIG. 6 is a flow chart 36 illustrating the method of use of the universal wiper blade assembly 24 of the instant invention. The first step 38 is assembly of the parts of the universal assembly, which includes the gear box with shaft to connect to the wiper arm and blade, the motor and the motor cover with preset programmed electronics housed therein. The second step 40 is the installation of individual mounts for permanent installation on an individual aircraft. The third step 42 is the installation on the mount of one side of the windshield, selecting the preset for the individual aircraft and the testing. Once found to be successful, the final step 44 is the installation on the mount on the opposing side of the windshield, selecting the same preset for the individual aircraft and performing the final test.

The invention illustratively disclosed herein suitably may be practiced in the absence of any element which is not specifically disclosed herein.

The discussion included in this detailed description is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

1. A universal windshield wiper assembly set for all particular models of aircraft comprising:
a first mount for a first side of a particular aircraft's windshield;
a second mount for a second side of said particular aircraft's windshield
wherein said first and second mounts for said particular aircraft are customized for said particular aircraft for permanent installation thereon;
a first universal windshield wiper assembly, said first universal windshield wiper assembly further comprising:
a first gear box;
a first shaft attached to said first gear box for affixing to a first windshield wiper arm;
a first motor to turn said first gear box;
electronics that are pre-programmed with presets to match specifications of said particular aircraft; and
a first motor cover with said electronics embedded therein wherein said first windshield wiper assembly is affixed on said first mount;
a second universal windshield wiper assembly, said second universal windshield wiper assembly further comprising:
a second gear box;
a second shaft attached to said said gear box for affixing to a second windshield wiper arm;
a second motor to turn said second gear box;
electronics that are pre-programmed with presets to match specifications of said particular aircraft; and
a second motor cover with said electronics embedded therein wherein said second windshield wiper assembly is affixed on said second mount.

2. The universal windshield wiper assembly set as defined claim 1 wherein said first and second motors is are internally commutated.

3. The universal windshield wiper assembly set as defined in claim 1 wherein said first and second motors is are externally commutated.

4. The universal windshield wiper assembly set as defined in claim 1 wherein said first and second motors is are asynchronous relative to each other.

5. A system for providing a universal windshield wiper blade assembly set at aircraft depots that can be used with all models of aircraft, said system further comprising:
first and second individual mounts for permanent installation on a particular aircraft customized for said particular aircraft;
pre-set electronic programming that includes specifications for of said particular aircraft;
embedding of said electronic programming inside a first and second motor cover for a first a and second universal windshield wiper assembly, respectively;
placing said first and second motor covers over a first and second motors, respectively;
connecting said first and second motors to a first and second gear boxes, respectively, said first and second gear boxes including a first and second shaft, respectively that attaches to a said first and second windshield wiper assemblies;
selecting the pre-set electronic programming for said particular aircraft on a first side of a cockpit of said specific type of aircraft; and
selecting the pre-set electronic programming for said particular aircraft on an opposing second side of said cockpit of said particular aircraft.

6. The system as defined in claim 5 wherein said first and second motors are internally commutated.

7. The system as defined in claim 5 wherein said first and second motors are externally commutated.

8. The system as defined in claim 5 wherein said first and second motors are asynchronous relative to each other.

9. A method of installing a universal windshield wiper assembly set on all models of aircraft, said method comprising the steps of:
providing a universal windshield wiper assembly set, said universal windshield wiper assembly set being mountable and adaptable on all models of aircraft, said universal windshield wiper assembly set further comprising:
a first universal windshield wiper assembly further comprising:
a first gear box;
a first shaft attached to said first gear box for affixing to a first windshield wiper arm;
a first motor to turn said first gear box;
a first set of electronics embedded in said first gear box that are pre-programmed with presets to match specifications of a particular aircraft to determine the speed and torque required for said particular aircraft; and
a first motor cover with said electronics embedded therein;
a second universal windshield wiper assembly further comprising:
a second gear box;
a second shaft attached to said second gear box for affixing to a second windshield wiper arm;
a second motor to turn said second gear box;
a second set of electronics embedded in said second gear box that are pre-programmed with presets to match specifications of said particular aircraft to determine the speed and torque required for said particular aircraft; and
a second motor cover with said electronics embedded therein
installing a first side mount on to a first side of a windshield of said particular aircraft, said first side mount being designed for said particular aircraft;
affixing said first universal windshield wiper assembly on to said first side mount on said first side of said windshield of said particular aircraft;
testing on said first side to ensure said first set of electronics of said first motor accurately performs the proper torque and speed for said particular aircraft; and
installing a second side mount on to a second side of said windshield of said particular aircraft, said second side mount being designed for said particular aircraft;
affixing said second universal windshield wiper assembly on to an opposing second side mount on said opposing second side of said windshield of said particular aircraft;
testing on said second side to ensure said second set of electronics of said second motor accurately performs the proper torque and speed for said particular aircraft.

10. The method as defined in claim as defined claim 9 wherein said first and second motors are internally commutated.

11. The method as defined in claim 9 wherein said first and second motors are externally commutated.

12. (canceled)
